(19) United States
(12) Patent Application Publication
(10) Pub. No.: US 2025/0388088 A1
(43) Pub. Date: Dec. 25, 2025

(54) ELECTRIC VEHICLE IMMOBILIZING DEVICE

(71) Applicant: Midtronics, Inc., Willowbrook, IL (US)

(72) Inventor: Kevin I. Bertness, Batavia, IL (US)

(21) Appl. No.: 19/242,318

(22) Filed: Jun. 18, 2025

Related U.S. Application Data
(60) Provisional application No. 63/662,101, filed on Jun. 20, 2024.

(51) Int. Cl. B60L 3/04; B60L 53/16

(52) U.S. Cl. CPC B60L 3/04; B60L 53/16; B60L 2240/12; B60L 2240/547

(57) ABSTRACT

An immobilizer for immobilizing an electric vehicle, includes a handheld housing including a charging plug end adapted to fit in a charging port of the electric vehicle, control pilot electrical connectors adapted to make electrical contact with control pilot electrical terminals and proximity pilot electrical connectors adapted to make electrical contact with proximity pilot electrical terminals are provided. A voltage sensor coupled to the control pilot electrical connectors is arranged to measure a voltage of the control pilot electrical terminals. Operator output circuitry provides an output to an operator indicating the electric vehicle is immobilized. The microprocessor is coupled to the voltage sensor and controls the operator output in response to a voltage drop measured by the voltage sensor on the control pilot electrical terminals of the electric vehicle.

### CROSS-REFERENCE TO RELATED APPLICATION

The present application is based on and claims the benefit of U.S. provisional patent application Ser. No. 63/662,101, filed Jun. 20, 2024, the content of which is hereby incorporated by reference in its entirety.

### BACKGROUND

The disclosure described herein relates to electric vehicles of the type that use battery packs for storing electricity and power the vehicle. This includes both hybrid and purely electric vehicles. More specifically, the present invention relates to the disabling of such vehicles for safety purposes.

Traditionally, automotive vehicles have used internal combustion engines as their power source. However, vehicles which are electrically powered are finding widespread use. Such vehicles can provide increased fuel efficiency and can be operated using alternative energy sources.

Some types of electric vehicles (xEV) are completely powered using electric motors and electricity. Other types of electric vehicles include an internal combustion engine. The internal combustion engine may be used to generate electricity and supplement the power delivered by the electric motor. These types of vehicles are known as “hybrid” electric vehicles.

Operation of an electric vehicle requires a power source capable of providing large amounts of electricity. Typically, electric vehicles store electricity in large battery packs which consist of a plurality of batteries. These batteries may be formed by a number of individual cells, or may themselves be individual cells, depending on the configuration of the battery and battery pack. The packs are large, replacement may be expensive, and they may be difficult to access and maintain. Further, the connections to the battery pack are typically at a relatively high voltage.

When a vehicle having an internal combustion engine requires maintenance, is in an accident, or otherwise must be disabled, the engine can be turned off and the vehicle can be safely interacted with. However, with a vehicle having a battery power source, the battery cannot simply be turned “off.” It is not readily apparent to an operator that the vehicle has been disabled. The battery can engage with electric motors or other components of the vehicle making it difficult, or even unsafe, for the vehicle to be worked on.

Various aspects of vehicle maintenances devices are disclosed and can be performed in accordance with techniques pioneered by Midtronics, Inc. of Willowbrook, Illinois, and Dr. Keith S. Champlin, including for example, those discussed in U.S. Pat. No. 3,873,911, issued Mar. 25, 1975, to Champlin; U.S. Pat. No. 3,909,708, issued Sep. 30, 1975, to Champlin; U.S. Pat. No. 4,816,768, issued Mar. 28, 1989, to Champlin; U.S. Pat. No. 4,825,170, issued Apr. 25, 1989, to Champlin; U.S. Pat. No. 4,881,038, issued Nov. 14, 1989, to Champlin; U.S. Pat. No. 4,912,416, issued Mar. 27, 1990, to Champlin; U.S. Pat. No. 5,140,269, issued Aug. 18, 1992, to Champlin; U.S. Pat. No. 5,343,380, issued Aug. 30, 1994; U.S. Pat. No. 5,572,136, issued Nov. 5, 1996; U.S. Pat. No. 5,574,355, issued Nov. 12, 1996; U.S. Pat. No. 5,583,416, issued Dec. 10, 1996; U.S. Pat. No. 5,585,728, issued Dec. 17, 1996; U.S. Pat. No. 5,589,757, issued Dec. 31, 1996; U.S. Pat. No. 5,592,093, issued Jan. 7, 1997; U.S. Pat. No. 5,598,098, issued Jan. 28, 1997; U.S. Pat. No. 5,656,920, issued Aug. 12, 1997; U.S. Pat. No. 5,757,192, issued May 26, 1998; U.S. Pat. No. 5,821,756, issued Oct. 13, 1998; U.S. Pat. No. 5,831,435, issued Nov. 3, 1998; U.S. Pat. No. 5,871,858, issued Feb. 16, 1999; U.S. Pat. No. 5,914,605, issued Jun. 22, 1999; U.S. Pat. No. 5,945,829, issued Aug. 31, 1999; U.S. Pat. No. 6,002,238, issued Dec. 14, 1999; U.S. Pat. No. 6,037,751, issued Mar. 14, 2000; U.S. Pat. No. 6,037,777, issued Mar. 14, 2000; U.S. Pat. No. 6,051,976, issued Apr. 18, 2000; U.S. Pat. No. 6,081,098, issued Jun. 27, 2000; U.S. Pat. No. 6,091,245, issued Jul. 18, 2000; U.S. Pat. No. 6,104,167, issued Aug. 15, 2000; U.S. Pat. No. 6,137,269, issued Oct. 24, 2000; U.S. Pat. No. 6,163,156, issued Dec. 19, 2000; U.S. Pat. No. 6,172,483, issued Jan. 9, 2001; U.S. Pat. No. 6,172,505, issued Jan. 9, 2001; U.S. Pat. No. 6,222,369, issued Apr. 24, 2001; U.S. Pat. No. 6,225,808, issued May 1, 2001; U.S. Pat. No. 6,249,124, issued Jun. 19, 2001; U.S. Pat. No. 6,259,254, issued Jul. 10, 2001; U.S. Pat. No. 6,262,563, issued Jul. 17, 2001; U.S. Pat. No. 6,294,896, issued Sep. 25, 2001; U.S. Pat. No. 6,294,897, issued Sep. 25, 2001; U.S. Pat. No. 6,304,087, issued Oct. 16, 2001; U.S. Pat. No. 6,310,481, issued Oct. 30, 2001; U.S. Pat. No. 6,313,607, issued Nov. 6, 2001; U.S. Pat. No. 6,313,608, issued Nov. 6, 2001; U.S. Pat. No. 6,316,914, issued Nov. 13, 2001; U.S. Pat. No. 6,323,650, issued Nov. 27, 2001; U.S. Pat. No. 6,329,793, issued Dec. 11, 2001; U.S. Pat. No. 6,331,762, issued Dec. 18, 2001; U.S. Pat. No. 6,332,113, issued Dec. 18, 2001; U.S. Pat. No. 6,351,102, issued Feb. 26, 2002; U.S. Pat. No. 6,359,441, issued Mar. 19, 2002; U.S. Pat. No. 6,363,303, issued Mar. 26, 2002; U.S. Pat. No. 6,377,031, issued Apr. 23, 2002; U.S. Pat. No. 6,392,414, issued May 21, 2002; U.S. Pat. No. 6,417,669, issued Jul. 9, 2002; U.S. Pat. No. 6,424,158, issued Jul. 23, 2002; U.S. Pat. No. 6,441,585, issued Aug. 17, 2002; U.S. Pat. No. 6,437,957, issued Aug. 20, 2002; U.S. Pat. No. 6,445,158, issued Sep. 3, 2002; U.S. Pat. Nos. 6,456,045; 6,466,025, issued Oct. 15, 2002; U.S. Pat. No. 6,465,908, issued Oct. 15, 2002; U.S. Pat. No. 6,466,026, issued Oct. 15, 2002; U.S. Pat. No. 6,469,511, issued Nov. 22, 2002; U.S. Pat. No. 6,495,990, issued Dec. 17, 2002; U.S. Pat. No. 6,497,209, issued Dec. 24, 2002; U.S. Pat. No. 6,507,196, issued Jan. 14, 2003; U.S. Pat. No. 6,534,993; issued Mar. 18, 2003; U.S. Pat. No. 6,544,078, issued Apr. 8, 2003; U.S. Pat. No. 6,556,019, issued Apr. 29, 2003; U.S. Pat. No. 6,566,883, issued May 20, 2003; U.S. Pat. No. 6,586,941, issued Jul. 1, 2003; U.S. Pat. No. 6,597,150, issued Jul. 22, 2003; U.S. Pat. No. 6,621,272, issued Sep. 16, 2003; U.S. Pat. No. 6,623,314, issued Sep. 23, 2003; U.S. Pat. No. 6,633,165, issued Oct. 14, 2003; U.S. Pat. No. 6,635,974, issued Oct. 21, 2003; U.S. Pat. No. 6,696,819, issued Feb. 24, 20144; U.S. Pat. No. 6,707,303, issued Mar. 16, 2004; U.S. Pat. No. 6,737,831, issued May 18, 2004; U.S. Pat. No. 6,744,149, issued Jun. 1, 2004; U.S. Pat. No. 6,759,849, issued Jul. 6, 2004; U.S. Pat. No. 6,781,382, issued Aug. 24, 2004; U.S. Pat. No. 6,788,025, filed Sep. 7, 2004; U.S. Pat. No. 6,795,782, issued Sep. 21, 2004; U.S. Pat. No. 6,805,090, filed Oct. 19, 2004; U.S. Pat. No. 6,806,716, filed Oct. 19, 2004; U.S. Pat. No. 6,850,037, filed Feb. 1, 2005; U.S. Pat. No. 6,850,037, issued Feb. 1, 2005; U.S. Pat. No. 6,871,151, issued Mar. 22, 2005; U.S. Pat. No. 6,885,195, issued Apr. 26, 2005; U.S. Pat. No. 6,888,468, issued May 3, 2005; U.S. Pat. No. 6,891,378, issued May 10, 2005; U.S. Pat. No. 6,906,522, issued Jun. 14, 2005; U.S. Pat. No. 6,906,523, issued Jun. 14, 2005; U.S. Pat. No. 6,909,287, issued Jun. 21, 2005; U.S. Pat. No. 6,914,413, issued Jul. 5, 2005; U.S. Pat. No. 6,913,483, issued Jul. 5, 2005; U.S. Pat. No. 6,930,485, issued Aug. 16, 2005; U.S. Pat. No. 6,933,727, issued Aug. 23, 200; U.S. Pat. No. 6,941,234, filed Sep. 6, 2005; U.S. Pat. No. 6,967,484, issued Nov. 22, 2005; U.S. Pat. No. 6,998,847, issued Feb. 14, 2006; U.S. Pat. No. 7,003,410, issued Feb. 21, 2006; U.S. Pat. No. 7,003,411, issued Feb. 21, 2006; U.S. Pat. No. 7,012,433, issued Mar. 14, 2006; U.S. Pat. No. 7,015,674, issued Mar. 21, 2006; U.S. Pat. No. 7,034,541, issued Apr. 25, 2006; U.S. Pat. No. 7,039,533, issued May 2, 2006; U.S. Pat. No. 7,058,525, issued Jun. 6, 2006; U.S. Pat. No. 7,081,755, issued Jul. 25, 2006; U.S. Pat. No. 7,106,070, issued Sep. 12, 2006; U.S. Pat. No. 7,116,109, issued Oct. 3, 2006; U.S. Pat. No. 7,119,686, issued Oct. 10, 2006; and U.S. Pat. No. 7,126,341, issued Oct. 24, 2006; U.S. Pat. No. 7,154,276, issued Dec. 26, 2006; U.S. Pat. No. 7,198,510, issued Apr. 3, 2007; U.S. Pat. No. 7,363,175, issued Apr. 22, 2008; U.S. Pat. No. 7,208,914, issued Apr. 24, 2007; U.S. Pat. No. 7,246,015, issued Jul. 17, 2007; U.S. Pat. No. 7,295,936, issued Nov. 13, 2007; U.S. Pat. No. 7,319,304, issued Jan. 15, 2008; U.S. Pat. No. 7,363,175, issued Apr. 22, 2008; U.S. Pat. No. 7,398,176, issued Jul. 8, 2008; U.S. Pat. No. 7,408,358, issued Aug. 5, 2008; U.S. Pat. No. 7,425,833, issued Sep. 16, 2008; U.S. Pat. No. 7,446,536, issued Nov. 4, 2008; U.S. Pat. No. 7,479,763, issued Jan. 20, 2009; U.S. Pat. No. 7,498,767, issued Mar. 3, 2009; U.S. Pat. No. 7,501,795, issued Mar. 10, 2009; U.S. Pat. No. 7,505,856, issued Mar. 17, 2009; U.S. Pat. No. 7,545,146, issued Jun. 9, 2009; U.S. Pat. No. 7,557,586, issued Jul. 7, 2009; U.S. Pat. No. 7,595,643, issued Sep. 29, 2009; U.S. Pat. No. 7,598,699, issued Oct. 6, 2009; U.S. Pat. No. 7,598,744, issued Oct. 6, 2009; U.S. Pat. No. 7,598,743, issued Oct. 6, 2009; U.S. Pat. No. 7,619,417, issued Nov. 17, 2009; U.S. Pat. No. 7,642,786, issued Jan. 5, 2010; U.S. Pat. No. 7,642,787, issued Jan. 5, 2010; U.S. Pat. No. 7,656,162, issued Feb. 2, 2010; U.S. Pat. No. 7,688,074, issued Mar. 30, 2010; U.S. Pat. No. 7,705,602, issued Apr. 27, 2010; U.S. Pat. No. 7,706,992, issued Apr. 27, 2010; U.S. Pat. No. 7,710,119, issued May 4, 2010; U.S. Pat. No. 7,723,993, issued May 25, 2010; U.S. Pat. No. 7,728,597, issued Jun. 1, 2010; U.S. Pat. No. 7,772,850, issued Aug. 10, 2010; U.S. Pat. No. 7,774,151, issued Aug. 10, 2010; U.S. Pat. No. 7,777,612, issued Aug. 17, 2010; U.S. Pat. No. 7,791,348, issued Sep. 7, 2010; U.S. Pat. No. 7,808,375, issued Oct. 5, 2010; U.S. Pat. No. 7,924,015, issued Apr. 12, 2011; U.S. Pat. No. 7,940,053, issued May 10, 2011; U.S. Pat. No. 7,940,052, issued May 10, 2011; U.S. Pat. No. 7,959,476, issued Jun. 14, 2011; U.S. Pat. No. 7,977,914, issued Jul. 12, 2011; U.S. Pat. No. 7,999,505, issued Aug. 16, 2011; U.S. Pat. No. D643,759, issued Aug. 23, 2011; U.S. Pat. No. 8,164,343, issued Apr. 24, 2012; U.S. Pat. No. 8,198,900, issued Jun. 12, 2012; U.S. Pat. No. 8,203,345, issued Jun. 19, 2012; U.S. Pat. No. 8,237,448, issued Aug. 7, 2012; U.S. Pat. No. 8,306,690, issued Nov. 6, 2012; U.S. Pat. No. 8,344,685, issued Jan. 1, 2013; U.S. Pat. No. 8,436,619, issued May 7, 2013; U.S. Pat. No. 8,442,877, issued May 14, 2013; U.S. Pat. No. 8,493,022, issued Jul. 23, 2013; U.S. Pat. No. D687,727, issued Aug. 13, 2013; U.S. Pat. No. 8,513,949, issued Aug. 20, 2013; U.S. Pat. No. 8,674,654, issued Mar. 18, 2014; U.S. Pat. No. 8,674,711, issued Mar. 18, 2014; U.S. Pat. No. 8,704,483, issued Apr. 22, 2014; U.S. Pat. No. 8,738,309, issued May 27, 2014; U.S. Pat. No. 8,754,653, issued Jun. 17, 2014; U.S. Pat. No. 8,872,516, issued Oct. 28, 2014; U.S. Pat. No. 8,872,517, issued Oct. 28, 2014; U.S. Pat. No. 8,958,998, issued Feb. 17, 2015; U.S. Pat. No. 8,963,550, issued Feb. 24, 2015; U.S. Pat. No. 9,018,958, issued Apr. 28, 2015; U.S. Pat. No. 9,052,366, issued Jun. 9, 2015; U.S. Pat. No. 9,201,120, issued Dec. 1, 2015; U.S. Pat. No. 9,229,062, issued Jan. 5, 20126; U.S. Pat. No. 9,244,100, issued Jan. 26, 2016; U.S. Pat. No. 9,255,955, issued Feb. 9, 2016; U.S. Pat. No. 9,274,157, issued Mar. 1, 2016; U.S. Pat. No. 9,312,575, issued Apr. 12, 2016; U.S. Pat. No. 9,335,362, issued May 10, 2016; U.S. Pat. No. 9,425,487, issued Aug. 23, 2016; U.S. Pat. No. 9,419,311, issued Aug. 16, 2016; U.S. Pat. No. 9,496,720, issued Nov. 15, 2016; U.S. Pat. No. 9,588,185, issued Mar. 7, 2017; U.S. Pat. No. 9,923,289, issued Mar. 20, 2018; U.S. Pat. No. 9,966,676, issued May 8, 2018; U.S. Pat. No. 10,046,649, issued Aug. 14, 2018; U.S. Pat. No. 10,222,397, issued Mar. 5, 2019; U.S. Pat. No. 10,317,468, issued Jun. 11, 2019; U.S. Pat. No. 10,429,449, issued Oct. 1, 2019; U.S. Pat. No. 10,473,555, issued Nov. 12, 2019; U.S. Pat. No. 10,608,353, issued Mar. 31, 2020; U.S. Pat. No. 10,843,574, issued Nov. 24, 2020; U.S. Pat. No. 11,054,480, issued Jul. 6, 2021; U.S. Pat. No. 11,325,479, issued May 10, 2022; U.S. Pat. No. 11,474,153, issued Oct. 18, 2022; U.S. Pat. No. 11,486,930, issued Nov. 1, 2022; U.S. Pat. No. 11,513,160, issued Nov. 29, 2022; U.S. Pat. No. 11,545,839, issued Jan. 3, 2023; U.S. Pat. No. 11,548,404, issued Jan. 10, 2023; U.S. Pat. No. 11,566,972, issued Jan. 31, 2023; U.S. Pat. No. 11,650,259, issued May 16, 2023; U.S. Pat. No. 11,668,779, issued Jun. 6, 2023; U.S. Pat. No. 11,740,294, issued Aug. 29, 2023; U.S. Pat. No. 11,926,224, issued Mar. 12, 2024; U.S. Pat. No. 11,973,202, issued Apr. 30, 2024; U.S. Pat. No. 12,196,813, issued Jan. 14, 2025; U.S. Pat. No. 12,237,482, issued Feb. 25, 2025; U.S. Ser. No. 09/780,146, filed Feb. 9, 2001, entitled STORAGE BATTERY WITH INTEGRAL BATTERY TESTER; U.S. Ser. No. 09/756,638, filed Jan. 8, 2001, entitled METHOD AND APPARATUS FOR DETERMINING BATTERY PROPERTIES FROM COMPLEX IMPEDANCE/ADMITTANCE; U.S. Ser. No. 09/862,783, filed May 21, 2001, entitled METHOD AND APPARATUS FOR TESTING CELLS AND BATTERIES EMBEDDED IN SERIES/PARALLEL SYSTEMS; U.S. Ser. No. 09/880,473, filed Jun. 13, 2001; entitled BATTERY TEST MODULE; U.S. Ser. No. 10/109,734, filed Mar. 28, 2002, entitled APPARATUS AND METHOD FOR COUNTERACTING SELF DISCHARGE IN A STORAGE BATTERY; U.S. Ser. No. 10/263,473, filed Oct. 2, 2002, entitled ELECTRONIC BATTERY TESTER WITH RELATIVE TEST OUTPUT; U.S. Ser. No. 09/653,963, filed Sep. 1, 2000, entitled SYSTEM AND METHOD FOR CONTROLLING POWER GENERATION AND STORAGE; U.S. Ser. No. 10/174,110, filed Jun. 18, 2002, entitled DAYTIME RUNNING LIGHT CONTROL USING AN INTELLIGENT POWER MANAGEMENT SYSTEM; U.S. Ser. No. 10/258,441, filed Apr. 9, 2003, entitled CURRENT MEASURING CIRCUIT SUITED FOR BATTERIES; U.S. Ser. No. 10/681,666, filed Oct. 8, 2003, entitled ELECTRONIC BATTERY TESTER WITH PROBE LIGHT; U.S. Ser. No. 11/207,419, filed Aug. 19, 2005, entitled SYSTEM FOR AUTOMATICALLY GATHERING BATTERY INFORMATION FOR USE DURING BATTERY TESTER/CHARGING, U.S. Ser. No. 11/356,443, filed Feb. 16, 2006, entitled ELECTRONIC BATTERY TESTER WITH NETWORK COMMUNICATION; U.S. Ser. No. 12/697,485, filed Feb. 1, 2010, entitled ELECTRONIC BATTERY TESTER; U.S. Ser. No. 12/769,911, filed Apr. 29, 2010, entitled STATIONARY BATTERY TESTER; U.S. Ser. No. 13/152,711, filed Jun. 3, 2011, entitled BATTERY PACK MAINTENANCE FOR ELECTRIC VEHICLE; U.S. Ser. No. 14/039,746, filed Sep. 27, 2013, entitled BATTERY PACK MAINTENANCE FOR ELECTRIC VEHICLE; U.S. Ser. No. 14/565,589, filed Dec. 10, 2014, entitled BATTERY TESTER AND BATTERY REGISTRATION TOOL; U.S. Ser. No. 15/017,887, filed Feb. 8, 2016, entitled METHOD AND APPARATUS FOR MEASURING A PARAMETER OF A VEHICLE ELECTRICAL SYSTEM; U.S. Ser. No. 15/049,483, filed Feb. 22, 2016, entitled BATTERY TESTER FOR ELECTRIC VEHICLE; U.S. Ser. No. 15/077,975, filed Mar. 23, 2016, entitled BATTERY MAINTENANCE SYSTEM; U.S. Ser. No. 15/149,579, filed May 9, 2016, entitled BATTERY TESTER FOR ELECTRIC VEHICLE; U.S. Ser. No. 16/253,526, filed Jan. 22, 2019, entitled HIGH CAPACITY BATTERY BALANCER; U.S. Ser. No. 17/364,953, filed Jul. 1, 2021, entitled ELECTRICAL LOAD FOR ELECTRONIC BATTERY TESTER AND ELECTRONIC BATTERY TESTER INCLUDING SUCH ELECTRICAL LOAD; U.S. Ser. No. 17/504,897, filed Oct. 19, 2021, entitled HIGH CAPACITY BATTERY BALANCER; U.S. Ser. No. 17/750,719, filed May 23, 2022, entitled BATTERY MONITORING SYSTEM; U.S. Ser. No. 17/893,412, filed Aug. 23, 2022, entitled POWER ADAPTER FOR AUTOMOTIVE VEHICLE MAINTENANCE DEVICE; U.S. Ser. No. 18/166,702, filed Feb. 9, 2023, entitled BATTERY MAINTENANCE DEVICE WITH HIGH VOLTAGE CONNECTOR; U.S. Ser. No. 18/314,266, filed May 9, 2023, entitled ELECTRONIC BATTERY TESTER, U.S. Ser. No. 18/324,382, filed May 26, 2023, entitled STACKABLE BATTERY MAINTENANCE SYSTEM, U.S. Ser. No. 18/328,827, filed Jun. 5, 2023, entitled ELECTRIC VEHICLE BATTERY STORAGE VESSEL; U.S. Ser. No. 18/616,458, filed Mar. 26, 2024, entitled EV BATTERY CHARGING SOLUTION FOR CONTAINERS; U.S. Ser. No. 18/740,030, filed Jun. 11, 2024 U.S. Ser. No. 18/914,573, filed Oct. 14, 2024, entitled ELECTRIC VEHICLE MAINTENANCE DEVICE; U.S. Ser. No. 18/930,713, filed Oct. 29, 2024, entitled VEHICLE MAINTENANCE SYSTEM WITH DYNAMIC NETWORK; U.S. Ser. No. 19/048,167, filed Feb. 7, 2025, entitled ELECTRIC VEHICLE MAINTENANCE DEVICE; U.S. Ser. No. 19/181,596, filed Apr. 17, 2025, entitled ELECTRIC VEHICLE BATTERY LEAK DETECTOR; all of which are incorporated herein by reference in their entireties.

### SUMMARY

An immobilizer for immobilizing an electric vehicle includes a handheld housing including a charging plug end adapted to fit in a charging port of the electric vehicle, control pilot electrical connectors adapted to make electrical contact with control pilot electrical terminals and proximity pilot electrical connectors adapted to make electrical contact with proximity pilot electrical terminals are provided. A microprocessor is provided in the handheld housing along with input/output circuitry coupled to the control pilot electrical connectors and the proximity pilot electrical connectors, the input/output circuitry includes a resistor configured to be coupled to the proximity pilot terminals thought the proximity pilot electrical connectors, a voltage source, a resistor configured to couple the voltage source to the control pilot electrical terminals through the control pilot electrical connectors, and a voltage sensor couple to the control pilot electrical connectors arrange to measure a voltage of the control pilot electrical terminals through the control pilot electrical connectors. Operator output circuitry provides an output to an operator indicating the electric vehicle is immobilized. The microprocessor is couple to the voltage sensor and controls the operator output in response to a voltage drop measured by the voltage sensor on the control pilot electrical terminals of the electric vehicle.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified block diagram of an electric vehicle immobilizer in accordance with one aspect of the present invention for coupling to, and disabling, an electrical vehicle.

FIG. 2 is a more detailed block diagram of the immobilizer of FIG. 1.

FIG. 3 is a simplified schematic diagram showing input/output circuitry of the immobilizer and the electric vehicle.

FIG. 4. is a graph of voltage versus time showing communication between the immobilizer and the electrical vehicle.

FIG. 5 is a perspective view of one example configuration of the immobilizer of FIG. 1.

### DETAILED DESCRIPTION OF ILLUSTRATIVE EMBODIMENT

Embodiments of the present disclosure are described more fully hereinafter with reference to the accompanying drawings. Elements that are identified using the same or similar reference characters refer to the same or similar elements. Some elements may not be shown in each of the figures in order to simplify the illustrations.

The various embodiments of the present disclosure may be embodied in many different forms and should not be construed as limited to the specific embodiments set forth herein. Rather, these embodiments are provided so that this disclosure will be thorough and complete, and will fully convey the scope of the present disclosure to those skilled in the art.

The present invention provides an electric vehicle immobilizing device, or immobilizer, for disabling an electric vehicle. The immobilizer attaches to a charging port of the vehicle and communicates with the vehicle to cause the vehicle to enter an “off” state in which the vehicle is not capable of engaging the large storage battery pack. The immobilizer communicates with the vehicle to ensure the vehicle is, in fact, in an immobilized state, and provides an indication to an operator that the vehicle is “off”. This allows an operator to perform maintenance on the vehicle, or a first responder to render assistance, without the vehicle potentially engaging the motors to operate the wheels or otherwise engaging the main battery pack.

Built into every electric vehicle that is capable of being charged from an external charging source, there is a circuit that will not allow the vehicle to move if the charge cable is connected. This prevents the vehicle from being driven away, which could expose high voltage charging connectors. In one aspect, the invention causes this circuit to activate and prevent the vehicle from moving while providing positive feedback to an operator to confirm that the vehicle has been immobilized.

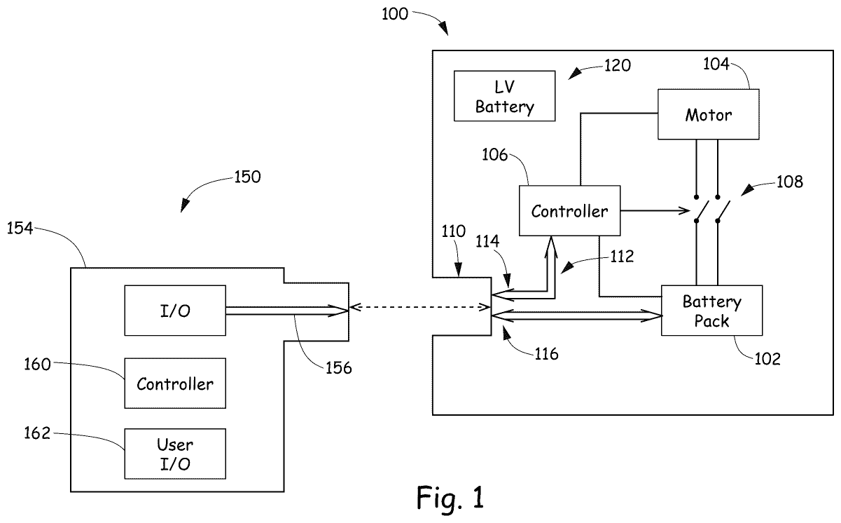

FIG. 1 is a simplified block diagram of an electric vehicle 100 including a battery pack 102, a motor 104, a controller 106 and contactors 108. A charging port 110 is provided for charging the battery pack 102 and communicating with the controller 106 through a databus 112. Charging port 110 includes data connectors 114 which connect to the databus 112, and charging connectors 116 for charging the battery pack 102. A low voltage battery 120 is also shown, which is used to power various electrical systems of vehicle 100.

During operation, when a charging plug from a charging station is placed in charging port 110, communication is provided through databus 112 to controller 106 causing the battery pack 102 to be disconnected from the motor 104 and other circuitry and vehicle 100. For example, this can be done by causing contactors 108 to open. This ensures that the vehicle 100 is in an immobilized state during charging. This ensures that if an operator attempts to operate the vehicle while a charging plug is in the charging port, the vehicle will not be able to be driven away. Should a vehicle be driven while plugged into a charging port, high voltage wiring from the charging station could break, thereby exposing high voltages to the vehicle operator or others.

As noted, when a vehicle has been in an accident or is being serviced, there is a potential for the motor 104 to be engaged with the battery pack 102. This could lead to injury of first responders or service personnel working on the electric vehicle 100. In one aspect, the present invention provides an electric vehicle immobilizer 150 which can be used to ensure that vehicle 100 is in an immobilized state, such that battery pack 102 cannot be inadvertently used to energize motor 104 or other devices of the vehicle 100. This could be caused by an operator inadvertently engaging the motor 104, or a system failure in vehicle 100 causing the motor 104 to connect with battery pack 102.

Immobilizer 150 includes a housing 154 having a charging plug 152 designed to be received by charging port 110. Charging plug 152 includes plug data connections 156 configured to electrically connect to data connectors 114 in the charging port 110. More than one charging plug 152 can be provided, such that immobilizer 150 can be used with different types of charging ports 110 which are used in different types of vehicles 100.

Immobilizer 150 includes a controller 160, a user input/output device 162 and input/output circuitry 164.

In operation, an operator, such as service personnel or a first responder, places charging plug 152 into charging port 110 thereby electrically connecting data connectors 114 with data connectors 156. This allows input/output circuitry 164 to communicate with databus 112 of vehicle 100, causing the controller 106 to disable the vehicle 100. In one example, this is achieved by opening contactors 108 thereby disconnecting the battery 102 from the motor 104. However, the disabling method employed by the vehicle 100 can be in accordance with any technique. Operation of the immobilizer 150 is controlled by controller 160. Input/output circuitry 164 is further configured to receive data from the vehicle 100 which indicates and confirms that the battery pack 102 has, in fact, been disabled and the vehicle 100 immobilized. When this signal is received and confirmed by controller 160, an output can be provided through user I/O 162 to the operator. User I/O 162 can include, for example, an indicator light, a speaker or other source of audio output, a display or other type of output device. This allows the operator to confirm that the vehicle 100 is in a safe condition to be worked on.

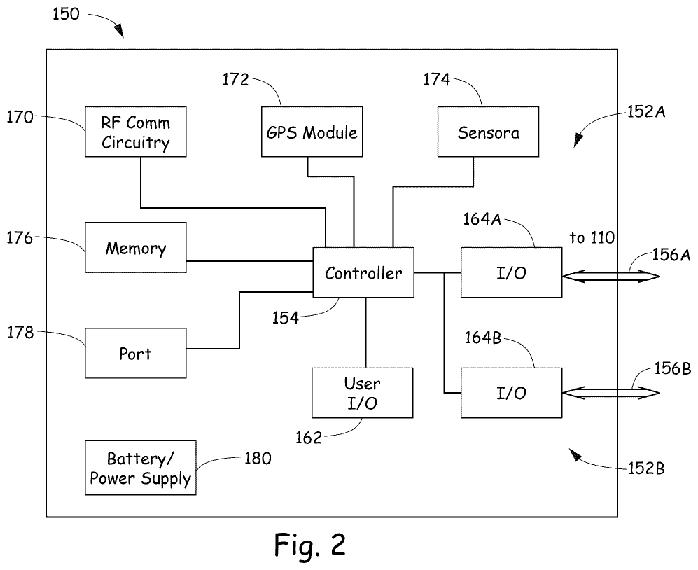

FIG. 2 is a more detailed block diagram of immobilizer 150. As illustrated in FIG. 2, immobilizer 150 includes RF communication circuitry 170, a GPS module 172, sensors 174, a memory 176, a data port 178 and a battery/power supply 180. In various configurations, the controller 154 can operate in accordance with instructions stored in memory 176. Memory 176 can also contain information related to vehicle type, data collected, time information, operator information, location information, various sensed or otherwise obtained parameters, etc. The sensors 174 include any type of sensor including, for example, temperature sensors, optical sensors, audio sensors, pressure sensors. The GPS module 172 is used to provide controller 174 with location information. RF communication circuitry 170 can be local and/or remote communication circuitry. Examples include data communication circuitry, Bluetooth® communication circuitry, WiFi communication circuitry, cellular communication circuitry, among others. WiFi, Bluetooth® or other local communication circuitry can be used to communicate with a local device, such as a support vehicle, cell phone, local hotspot, etc. which can then relay communication to a remote location. Data port 178 is used to provide a physical data connection and can comprise, for example, a USB connection, an Ethernet connection, or other type of data connection. The battery/power supply 180 is used to provide power to the various circuits within immobilizer 150. Typically, battery/power supply 180 is rechargeable and allows immobilizer 150 to be used at remote locations.

Charging plug 152A includes to input/output circuitry 164A and electrical connectors 156A. Similarly, charging plug 152B includes input/output circuitry 164B and electrical connectors 156B. In both cases, input/output circuitry 164A/164B communicates with controller 154.

In the configuration of immobilizer 150 shown in FIG. 2, two separate charging plugs 152A, 152B are provided. Any number of charging plugs 152 can be provided as desired. This allows the immobilizer 150 to be used with different types of charging ports 110 which may be used in different types of vehicles 100. In another example configuration, charging plug 152 is removable and can be replaced with a charging plug specific to the type of vehicle to which it is to be connected. In such a configuration, the immobilizer has multiple replaceable charging plugs which can be swapped in by an operator as needed, based upon the specific vehicle configuration,

The GPS module 172 can be used to locate the immobilizer 150 should it be lost or otherwise misplaced. The location information can be communicated, for example, using RF communication circuitry 170. Additionally, the location information can be used to communicate to a remote location that an emergency situation is occurring to dispatch additional responding personnel or for other purposes. Sensors 174 can, for example, collect information related to a hazardous situation such as high temperatures, the presence of toxic or explosive chemicals or gasses, the presence of dangerous electrical currents or voltages, or other information. In one configuration, sensors 174 include a camera which can be used to collect images of an accident or vehicle for storing in memory 176 or communicating using, for example, circuits 170 or 178 for analysis or to provide on the scene reporting should the device 150 be used at an accident scene.

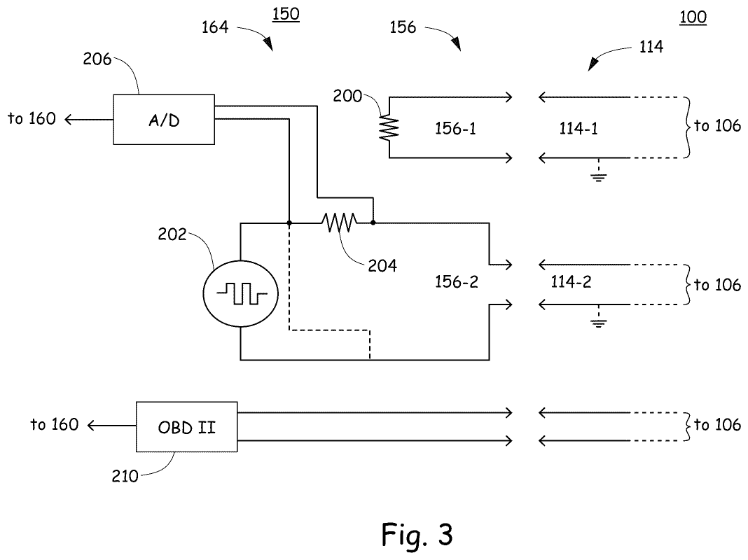

FIG. 3 is a simplified schematic diagram of input/output circuitry 164 coupling to vehicle 100. As illustrated in FIG. 3, connectors 156-1 and 114-1 provide a controlled interface to vehicle 100 such as a proximity control Pilot Connection. Similarly, terminals 156-2 and 114-2 provide a control pilot interface to vehicle 100. In the configuration of FIG. 3, a resistor 200 is provided for connection across terminals 156-1 and 114-1. This resistance provides an indication to controller 106 of vehicle 100 that a plug such as plug 152 has been plugged into charging port 110. This communicates to controller 106 that the vehicle 100 should be immobilized, for example, by opening contactors 108 shown in FIG. 1. At this point, the vehicle 100 should be immobilized and should be in a condition that it is safe to be operated upon. However, it is possible that the connectors 114 are damaged or some other problem exists which prevents the controller 106 from placing the vehicle into an immobilized state. If this is the case, the vehicle 100 is in a condition that it is unsafe to be operated on by service personnel or first responders.

Input/output circuitry 164 also includes a signal source 202 configured to couple to connectors 156-2 through a resistor 204. Connectors 156-2 and 114-2 can provide, for example, a connection to a Control Pilot interface through connectors of vehicle 100. An analog to digital converter 206 is connected across resistor 204 and/or connectors 156-2 and provides an output to controller 160 of immobilizer 150.

FIG. 3 also illustrates an optional databus communication circuitry 210 for communicating with a databus of vehicle 100. In the example configuration, the databus is configured as an OBDII databus. However, any type of databus may be implemented. This allows the immobilizer to receive additional information from vehicle 100 and control different aspect of components within vehicle 100. The databus connection can be through the plug 152 or through some alternative connector to vehicle 100. This can be used to obtain additional information about the vehicle 100, including diagnostic information which could be useful to maintenance personal or when attempting to ascertain a condition of a vehicle which has been in an accident.

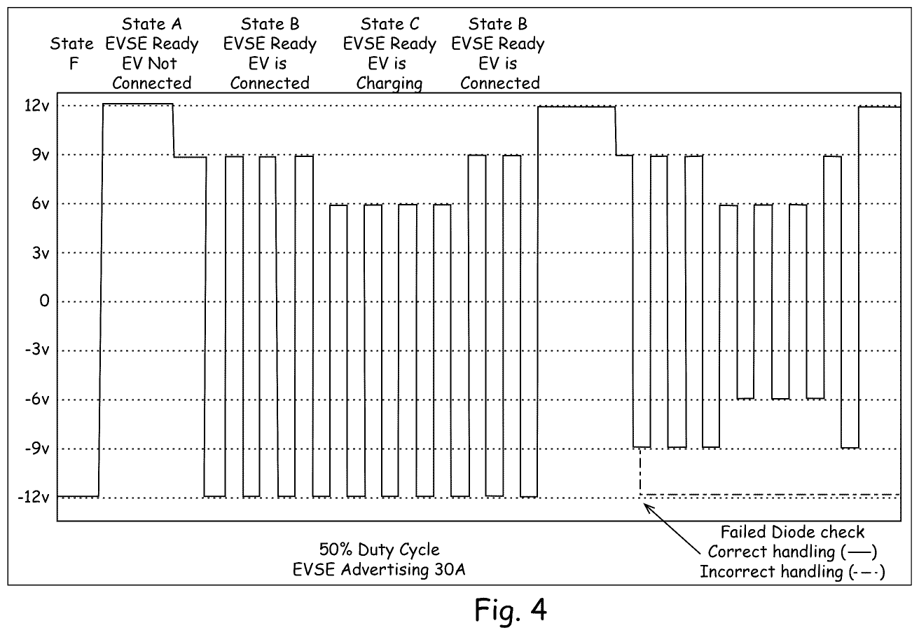

FIG. 4 is a graph of voltage versus time as measured across resistor 204 or connector 156-2 shown in FIG. 3 as communication occurs over the Control Pilot connection. Initially, when resistor 200 is placed across connectors 114-1, controller 106 immobilizes the vehicle 100. For example, the controller 106 can place the vehicle drive train in neutral or park, shift the vehicle “out of gear”, open the contactors 108, or otherwise immobilize the vehicle so that the motor 104 or other electrical systems of the vehicle 100 cannot be engaged with the battery pack 102. As illustrated in FIG. 4 “EV” refers to electrical vehicle 100 and “EVSE” refers to electric vehicle supply equipment as presented by immobilizer 150. In FIG. 4, in state A, a 12 volt signal is present on the Control Pilot connection. During the state A time period, the controller 106 of vehicle 100 draws the voltage down from 12 volts to 9 volts using, for example, a pull down resistor. This indicates that the controller 100 has sensed that a charging plug 152 has been placed into charging port 110 and connected a resistor 200 to connectors 114-1 shown in FIG. 3. Next, the signal source 202 in input/output circuitry 164 applies a square wave, for example, a 1 kHz square wave to the Control Pilot connection of connectors 114-2. This can be used to indicate the available charging current, for example, by adjusting the duty cycle as shown in state D. Note that immobilizer 150 does not actually supply a charging current. At state C, the controller 106 of vehicle 100 provides a positive indication that it is ready to receive a charge and that the vehicle has been immobilized. This is communicated by bringing the voltage to 6 volts. When controller 160 in immobilizer 150 observes that the vehicle has entered state C, it can make a determination that the vehicle 100 has, in fact, been immobilized. This state could also be further confirmed by communication with the databus of vehicle 100 by input/output circuitry 210.

Upon determination that the vehicle 100 has been immobilized, the controller 160 can use user input/output circuitry to provide a positive indication to an operator that the vehicle 100 has been immobilized. For example, an output light can be provided which switches from a red state to a green state. Additional information can be provided using a display. The user I/O 162 can also provide an audio output or other output techniques alerting the operator that the vehicle is in a safe condition. The invention is not limited to the particular signaling configuration illustrated in FIGS. 3 and 4. Any type of communication can be employed in which the vehicle 100 provides a positive communication to the immobilizer 150 that the battery pack has been placed in an immobilized state with respect to components within the vehicle 100.

FIG. 4 also illustrates communication used to report on diagnostic related to diodes used in the charging system. This can be used to further determine the severity of damage done to the vehicle 100.

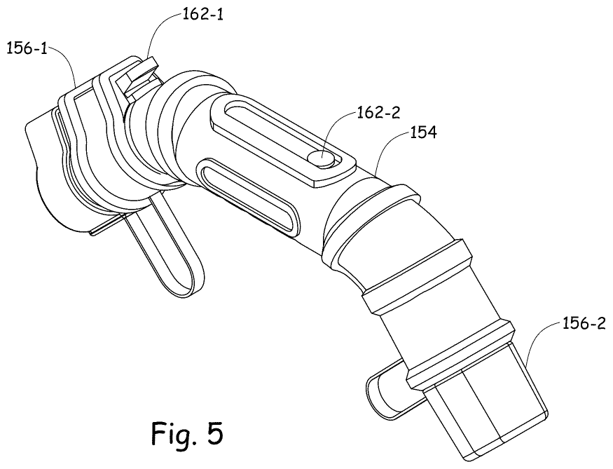

FIG. 5 is a perspective view of immobilizer 150 showing housing 154. The immobilizer 150 can be housed in a weatherproof housing such as an IP 56 rated housing, such that it is able to withstand shock, harsh environments, exposure to chemicals or liquids, etc. A clear portion of the housing 154 of the device can provide a view to an optical output located within the housing, such as an LED or a display. In one aspect, the user input/output 162 includes a physical button which can be used to release the plug 150 from the charging port 110 or otherwise communicate with controller 160. Similarly, such an input can be used to perform a test on the internal battery 180 of the immobilizer 150. This test can be in accordance with conductance testing, in which a forcing function is applied to a battery and a response measured. Other testing techniques can also be employed, including comparing battery voltage to a threshold. The housing 154 of immobilizer 150 can include tools for use by operating personnel such as a pry bar or other device to force a door or other access to a vehicle to open, tools for use in assisting first responders or mechanics, etc. The housing can also include an impact resistance shell to provide further protection. The actual plug 152, in one configuration, is removable such that it can be replaced with different standard connections based upon the vehicle 100.

In the configuration of FIG. 5, two charging plugs 156-1 and 156-2 are provided on opposing ends of housing 154. As noted above, this allows the immobilizer 150 to be used with two different types of charging ports 110 used in different types of vehicles 100. User input/output 162 is illustrated, for example, as a button 162-1 in FIG. 5. A visual output is illustrated as an LED 162-2.

In one configuration, the vehicle 100 can be in three possible operational states as determined by controller 160:
Vehicle 100 is immobilized.
Vehicle 100 is safe to work around.
Bright GREEN LEDs 162-2 on the immobilizer 150 which are visible from all angles are activated to indicate this state.

Vehicle 100 is NOT immobilized.
Vehicle 100 is NOT safe to work around.
Bright RED LEDs 162-2 on the immobilizer 150 which are visible from all angles are activated to indicate this state.
Vehicle 100 immobilization state cannot be determined.
This can happen for different reasons:
Vehicle is “asleep” and therefore not presenting signals to immobilizer 150. However, in this state, the vehicle 100 could still awaken at any time and move.
The immobilizer 150 will default to a protection status so that if the vehicle does wake up, it is not likely to move.
Vehicle 100 power has been cut.
Vehicle 100 would not move in this scenario at all.
Vehicle 100 immobilization circuit has been damaged.
The immobilizer 150 will default to a protection status so that if vehicle 100 does activate, it is less likely to move.
Bright FLASHING RED LEDs 162-2 on the immobilizer 150 are activated to indicate this state such that caution can be exercised.

Further, following a collision, high voltage can be present on terminals of the vehicle 100 where it should not be present.
The immobilizer 150 can measure this potential using, for example, A/D convertor 206 and report this specific condition on an OLED screen or other display 162-2, as well as flashing LEDs 162-2.

Although the present invention has been described with reference to preferred embodiments, workers skilled in the art will recognize that changes may be made in form and detail without departing from the spirit and scope of the invention. In one aspect, a stand-alone immobilizer is provided which can be plugged into the charging port of an electric vehicle and used to disable operation of the vehicle. Such an immobilizer provides additional functionality. A portable device for immobilizing operation of an electric vehicle includes an interface configured to plug into a charging port of the electric vehicle. Electric circuitry is configured to communicate with circuitry of the electric vehicle through the charging port to immobilize operation of the vehicle. A visual output indicates a status of the vehicle. Data collected by the immobilizer can be transmitted to a remote location using communication circuitry. This information can be transmitted to, for example, an emergency dispatch location, a vehicle service location, a vehicle manufacturing location, or others. The immobilizer is useful in any situation in which it is desirable to ensure that an electric vehicle is not operated. This includes emergency situations, while maintenance is performed on a vehicle, when a vehicle is placed in storage, while a vehicle is being transported, or for any other reason.

What is claimed is:

1. An immobilizer for immobilizing an electric vehicle, comprising:
a handheld housing including a charging plug end adapted to fit in a charging port of the electric vehicle;
control pilot electrical connectors in the charging plug end of the hand held housing, the control pilot electrical connectors adapted to make electrical contact with control pilot electrical terminals in the charging port of the electric vehicle;
proximity pilot electrical connectors in the charging plug end of the hand held housing, the proximity pilot electrical connectors adapted to make electrical contact with proximity pilot electrical terminals in the charging port of the electric vehicle; and
operator output circuitry configured to provide an output to an operator indicating the electric vehicle is immobilized based upon a signal received by the control pilot electrical connectors.

2. The immobilizer for immobilizing the electric vehicle of claim 1 including:
a microprocessor in the handheld housing; and
input/output circuitry in the housing coupled to the microprocessor, the control pilot electrical connectors and the proximity pilot electrical connectors.

3. The immobilizer for immobilizing the electric vehicle of claim 2 wherein the microprocessor is coupled to a voltage sensor and controls the operator output in response to a voltage drop measured by the voltage sensor on the control pilot electrical terminals of the electric vehicle.

4. The immobilizer for immobilizing the electric vehicle of claim 2 wherein the input/output circuitry includes:
a resistor configured to be coupled to the proximity pilot terminals thought the proximity pilot electrical connectors.

5. The immobilizer for immobilizing the electric vehicle of claim 2 wherein the input/output circuitry includes:
a voltage source configured to apply a voltage to the control pilot electrical connectors; and
a voltage sensor couple to the control pilot electrical connectors arrange to measure a voltage of the control pilot electrical terminals through the control pilot electrical connectors.

6. The immobilizer for immobilizing the electric vehicle of claim 5 wherein the input/output circuitry includes:
a resistor configured to couple the voltage source to the control pilot electrical terminals through the control pilot electrical connectors.

7. The immobilizer for immobilizing the electric vehicle of claim 1 wherein the operator output comprises an LED.

8. The immobilizer for immobilizing the electric vehicle of claim 1 wherein the operator output comprises a green light to indicate an immobilized condition of the electric vehicle.

9. The immobilizer for immobilizing the electric vehicle of claim 1 wherein the operator output comprises a red light to indicate an immobilized condition of the electric vehicle has not been met.

10. The immobilizer for immobilizing the electric vehicle of claim 1 wherein the operator output comprises a flashing light to indicate an immobilized condition of the electric vehicle is undetermined.

11. The immobilizer for immobilizing the electric vehicle of claim 5 wherein the microprocessor detects an immobilized state of the electric vehicle based upon a change in the applied voltage.

12. The immobilizer for immobilizing the electric vehicle of claim 11 wherein the change in the applied voltage comprises a voltage drop.

13. The immobilizer for immobilizing the electric vehicle of claim 1 including communication circuitry configured to communicate information with a remote location.

14. The immobilizer for immobilizing the electric vehicle of claim 13 wherein the information comprises location information.

15. The immobilizer for immobilizing the electric vehicle of claim 1 including a sensor configured to sense a condition of the electric vehicle.

16. The immobilizer for immobilizing the electric vehicle of claim 15 wherein the sensor comprises a temperature sensor.

17. The immobilizer for immobilizing the electric vehicle of claim 1 including OBDII communication circuitry configured to communicate with a databus of the electric vehicle.

18. The immobilizer for immobilizing the electric vehicle of claim 1 including a voltage sensor configured to sense a high voltage present on the vehicle.

19. The immobilizer for immobilizing the electric vehicle of claim 18 wherein the operator output circuitry provides an output in response to detection of high voltage by the voltage sensor.
